(19) United States
(12) Patent Application Publication
(10) Pub. No.: US 2002/0082866 A1
(43) Pub. Date: Jun. 27, 2002

(54) Integrated management of medical information

(76) Inventors: Dave Ladouceur, Boulder, CO (US); Scott Schorer, Lafayette, CO (US); Gregg Lauer, Boulder, CO (US); Todd Hoven, Ft. Collins, CO (US); Bruce Bacon, Littleton, CO (US); Mike Shell, Boulder, CO (US)

Correspondence Address: MATHEWS, COLLINS, SHEPHERD & GOULD, PA, 100 THANET CR, SUITE 306, PRINCETON, NJ, 08540, US

(21) Appl. No.: 09/909,500

(22) Filed: Jul. 20, 2001

Related U.S. Application Data
(63) Continuation-in-part of application No. 09/604,183, filed on Jun. 27, 2000.
(60) Provisional application No. 60/219,484, filed on Jul. 20, 2000.
(60) Provisional application No. 60/219,523, filed on Jul. 20, 2000.
(60) Provisional application No. 60/219,535, filed on Jul. 20, 2000.
(60) Provisional application No. 60/219,572, filed on Jul. 20, 2000.
(60) Provisional application No. 60/219,739, filed on Jul. 20, 2000.
(60) Provisional application No. 60/219,744, filed on Jul. 20, 2000.
(60) Provisional application No. 60/219,873, filed on Jul. 20, 2000.

(51) Int. Cl. G06F 17/60

(52) U.S. Cl. 705/2

(57) ABSTRACT

A system and method for integrated management of medical product information is disclosed. A dynamic interaction between medical procedures, medical products and product suppliers enables efficient decisions to be made concerning medical product procurement. The system of the present invention includes an appropriately configured server that is connected to a plurality of user computers and vendor computers via a communications network, such as the Internet. A user may choose from a product search option, a procedure search option, and a vendor search option to search information about medical products stored at the server. The product search option allows the user to choose from product categories and product sub-categories to select one or more vendor products. The procedure search option allows the user to choose a specific medical procedure and one or more product categories related to the selected medical procedure to select one or more vendor products. The vendor search option allows the user to select a specific vendor and a specific medical procedure to select one or products from a given vendor. A database at the server is indexed so as to provide these search capabilities. The user may also choose to request further information about selected products. The server receives the requests, compiles them, and transmits them to the appropriate vendor contacts. Alternatively, the user may choose to compare selected products, and the server displays a side-by-side comparison of the selected products. An integrated price quote request and response system is also provided.

### RELATED APPLICATIONS

This application is a continuation in part of co-pending U.S. patent application Ser. No. 09/604,183, filed on Jun. 27, 2000, entitled System And Method For Integrated Management Of Medical Product Information, having a common assign and a common inventor. This application claims the benefit of U.S. Provisional Patent Application Ser. No. 60/219,484 filed on Jul. 20, 2000, U.S. Provisional Patent Application Ser. No. 60/219,523 filed on Jul. 20, 2000, U.S. Provisional Patent Application Ser. No. 60/219,535 filed on Jul. 20, 2000, U.S. Provisional Patent Application Ser. No. 60/219,572 filed on Jul. 20, 2000, U.S. Provisional Patent Application Ser. No. 60/219,739 filed on Jul. 20, 2000, U.S. Provisional Patent Application Ser. No. 60/219,744 filed on Jul. 20, 2000, and U.S. Provisional Patent Application Ser. No. 60 /219,873 filed on Jul. 20, 2000.

### FIELD OF THE INVENTION

This invention relates to network-based communication systems and more particularly to the management of information about medical information over a communication network.

### BACKGROUND OF THE INVENTION

Physicians and other medical personnel such as hospital administrators are in constant need of up-to-date information about medical products that are relevant to their specialized practice. Such information is necessary to allow the physicians and administrators to make well-informed decisions regarding which vendor's products best meet their needs within their budgetary constraints. It would be desirable to provide powerful integrated searching tools, information retrieval mechanisms, and vendor request mechanisms that will assist medical personnel in making their medical-procurement decisions.

### SUMMARY OF THE INVENTION

The present invention is an integrated management system for medical information. A dynamic interaction between a digital database of medical procedures, medical products and product suppliers is provided with preferences and selective filtering.

### BRIEF DESCRIPTION OF THE DRAWINGS

A more complete understanding of the present invention may be obtained from consideration of the following description in conjunction with the drawings in which:

FIG. 1 is a stylized overview of interconnected computer system networks;

FIG. 2 is a schematic diagram illustrating a server configured in accordance with the preferred embodiment of the present invention;

FIG. 3(a) is a flowchart of the preferred general operation of the data searching mechanism of the present invention;

FIG. 3(b) is a flowchart of the preferred general operation of the information retrieval and request mechanisms of the present invention;

FIG. 4 is an illustrative web page depicting the preferred product search mechanism of the present invention;

FIG. 5 is another illustrative web page depicting the preferred product search mechanism of the present invention;

FIG. 6 is yet another illustrative web page depicting the preferred product search mechanism of the present invention;

FIG. 7 is an illustrative web page depicting the preferred procedure search mechanism of the present invention;

FIG. 8 is another illustrative web page depicting the preferred procedure search mechanism of the present invention;

FIG. 9 is yet another illustrative web page depicting the preferred procedure search mechanism of the present invention;

FIG. 10 is an illustrative web page depicting the preferred vendor search mechanism of the present invention;

FIG. 11 is an illustrative web page depicting an information folder;

FIG. 12 is an illustrative web page depicting a side-by-side comparison of selected medical products;

FIG. 13 is an illustrative information request web page;

FIG. 14 is an exemplary screen display of the physician specialty portal procedure detail;

FIG. 15 is an exemplary screen display of the physician specialty portal preference card;

FIG. 16 is an exemplary screen display of the physician specialty portal procedure with 3-D view;

FIG. 17 is an exemplary screen display of the physician specialty portal video display; and,

FIG. 18 is an exemplary screen display of the e-Commerce dashboard.

### DETAILED DESCRIPTION OF VARIOUS ILLUSTRATIVE EMBODIMENTS

Although the present invention, integrated management system for medical information, is particularly well suited for use with the Internet and shall be so described, the present invention is equally well suited for use in other network communication systems including but not limited to an Intranet, Interactive television (iTV), virtual private networks, and similar interactive networked communication systems. Although the present invention, integrated management system for medical information, is particularly well suited for use with medical information and shall be so described, the present invention is equally well suited for use in other professional business environments. Although the present invention, integrated management system for medical information, is particularly well suited for implementation as an independent software system and shall be so described, the present invention is equally well suited for implementation as a functional/library module, an applet, and as a plug-in software application.

The present invention is a system and method for integrated management of medical information. A dynamic interaction between medical procedures, medical products and product suppliers enables efficient decisions to me made concerning medical product procurement. The system of the present invention includes an appropriately configured server that is connected to a plurality of user computers and vendor computers via a communications network, such as the Internet. A user may choose from a product search option, a procedure search option, and a vendor search option to search information about medical products stored at the server. The product search option allows the user to choose from product categories and product sub-categories to select one or more vendor products. The procedure search option allows the user to choose a specific medical procedure and one or more product categories related to the selected medical procedure to select one or more vendor products. The vendor search option allows the user to select a specific vendor and a specific medical procedure to select one or products from a given vendor. A database at the server is indexed so as to provide these search capabilities. The user may also choose to request further information about selected products. The server receives the requests, compiles them, and transmits them to the appropriate vendor contacts. Alternatively, the user may choose to compare selected products, and the server displays a side-by-side comparison of the selected products. An integrated price quote request and response system is also provided. The system provides integration to purchasing systems and in-service training certification systems.

The present invention is a web-based business-to-business solution that streamlines information and commerce among all members of the healthcare supply chain. Combining the essential elements of content, community, commerce and workflow processing, the present invention provides robust portals that make it possible for hospitals physicians and suppliers to interact in real time over the Internet.

The medical device market, and the overlying healthcare market, trails most large industry segments in the adoption of technology and Internet solutions. Relationship selling lack of quality information, and the absence of responsible business practices dominate the industry. The typical healthcare user is characterized by reluctance to accept new technologies due to complexity issues, potential malpractice issues and medical insurance limitations.

While many promising new technologies have failed to overcome the massive entry barriers to healthcare automation, the Internet is clearly different. Two primary reasons make the Internet ideally suited to solving the healthcare IT puzzle: (i) the very low cost of adoption and deployment is ideally suited to the ultra-fragmented and margin-constrained healthcare industry and (ii) the online consumer is compelling physicians and large sponsors to embrace iHealth. The Internet's successful permeation of healthcare creates phenomenal investment opportunities, which collectively can only be measured in hundreds of billions of dollars. Digital medical record systems are evolving and being implemented. Increasingly, the potential of electronic health records in improving efficiency, safety and quality of care over paper-based systems is being recognized across the health sector.

Within the Integrated Delivery Netnews (IDN) environment, medical devices, pharmaceutical and commodity supplies typically account for 25-30% of total operating expenses. This figure is high compared to other industries and suggests that the healthcare industry's supply chain is relatively inefficient. By adopting a business model that leverages emerging developments in supply chain practices, technology and integration can significantly reduce an integrated delivery network's annual supply costs. By creating a low-cost and universally standardized communications network, knowledge may be disseminated and leveraged quickly and efficiently. Users of e-commerce-enabled web sites demand personalized experiences and expect Web resources to know them, what they need, and how they want to work. Web based e-commerce requires a knowledgeable intermediary to integrate different vendor formats and their complex products, and to deliver concise, up-to-date information to customers.

The present invention will facilitate every aspect of the procurement life cycle, from pre-sales decision processes to post-sales support by empowering the customer with critical information, facilitating communication and by connecting disparate system. An “infomediary” serving all members of the supply chain creates a central resource, providing a natural conduit for the transaction process. Once a small percentage of the market is represented in the information flow, the data itself becomes a valuable statistical analysis tool for all members of the transaction process. The present invention provides a central, manufacturer-supported catalog that supports every aspect of the hospital procurement environment, and connects hospitals and suppliers through open architecture.

Physicians are faced with a dramatically changing healthcare environment. With cost-control measures, driven by insurance providers and government, becoming increasingly important, physicians must make educated decisions when purchasing or using new medical devices. New products and procedures are of critical importance to physicians who must stay on the cutting edge of technology in order to remain competitive.

Today, the primary method in which healthcare professionals obtain product information is through manufacturer representatives and professional tradeshows. Physicians must make time-consuming consultations with the sales of representatives of individual vendors, each of who advocates the merits of their own company's products. This makes it difficult for healthcare professionals to compare and contrast similar products' features and clinical benefits. There is a substantial need for a resource that provides comprehensive information on technologically complex medical devices. Current purchasing and automation systems do not formally integrate the physician into the supply chain. The present invention provides the tools that tie the physician into the purchasing process.

A comprehensive database of all relevant clinical features, technical specifications and procedural information for the fourteen major surgical and interventional specialties is compiled. The medical product database, presents information customized for each target customer group. The database is organized by specialty, vendor, and medical procedure, and will be accessible to healthcare professionals and purchasers via the Internet.

The present invention differentiates products through specialty portals. Vendors may take full advantage of this new channel to sell directly to their customers, without negatively affecting current sales channels or pricing models. Working with leading vendors in each specialty enables the aggregation of catalog information for inclusion in respective specialty portals. Participation by vendors can access to customer profile data and be able to access real-time market information based on physician usage. In addition, vendors will be able to showcase new technologies and clinical studies, train physicians and hospital staff on new products and procedures, and pre-qualify physician targets. Manufacturers are provided with powerful content-management tools; the vendor provides subjective content. Information is kept current through connectivity to and by support of the vendor. Three different levels of catalog-hosting services are provided, determined by the manufacturer and the manufacturer's level of automation.

Specialty portals provide physicians with information specific to their field. The system aggregates information from multiple live news feeds, from manufacturers, and from trade journals, filters it, and presents only relevant information to the user. Physicians will have access to system's password-protected specialty portals. These portals will become the definitive physician portal, and are designed for each specialty sub-vertical-providing physicians with community-targeted information. Examples of physician portals for the surgical and interventional specialties include the following: radiology, oncology, critical care/ed, cardiology, orthopedic, general surgery, vascular, neurosurgery, urology, cardiovascular, otolaryngology, obstetrics and gynecology, plastic/reconstructive, ophthalmology, and anesthesiology.

Thought leaders (recognized medical professionals), working in conjunction with market development representatives, will monitor the websites to ensure that they system provides a neutral vendor forum. These physicians have allowed us to film leading-edge procedures that we are hosting on our website. These physicians also provide input regarding product prioritization, new procedure information, case cards, and basic information screening.

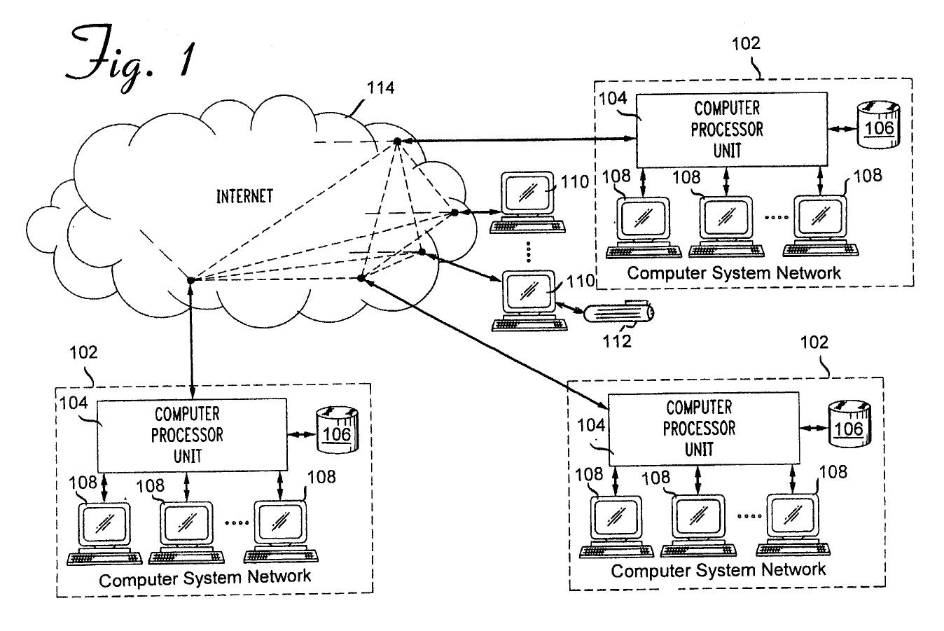

Referring to FIG. 1 there is shown a stylized overview of interconnected computer system networks. Each computer system network 102 contains a corresponding local computer processor unit 104, which are coupled to a corresponding local data storage unit 106, and local network users 108. The local computer processor units 104 are selectively coupled to a plurality of users 110 through the Internet 114. Each of the plurality of users 110 may have various devices connected to their local computer systems such as scanners, bar code readers, RFID detectors and other interface devices 112. A user 110 locates and selects (such as by clicking with a mouse) a particular Web page, the content of which is located on the local data storage unit 106 of the computer system network 102, to access the content of the web (world wide web) page. The web page may contain links to other computer systems and other web pages.

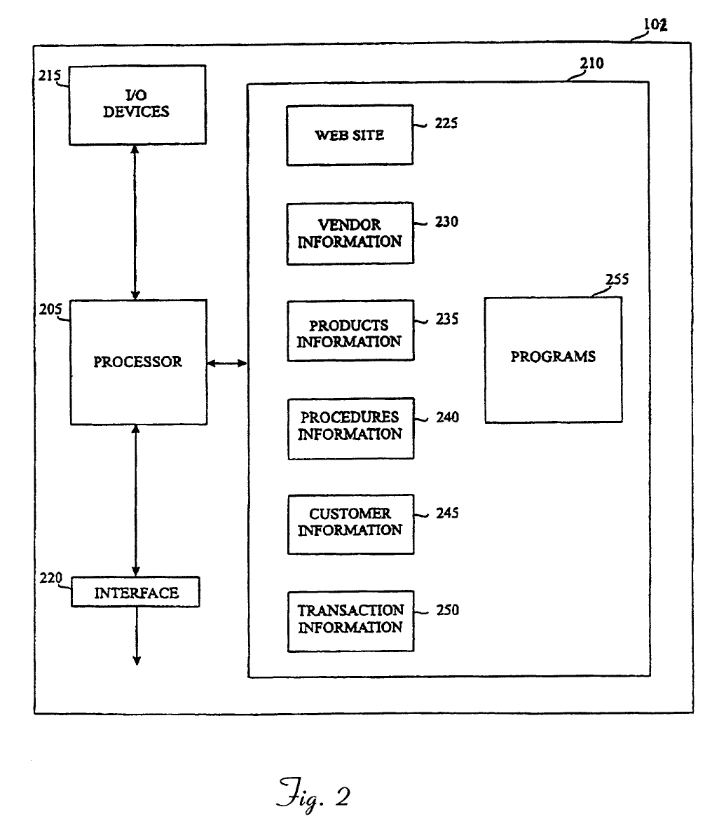

With reference to FIG. 2, computer system network (server) 102 preferably includes a processor 205, memory 210, I/O devices 215, and a network interface 220. Memory preferably includes a web site 225, a vendor database 230, a medical products database 235, a medical procedures database 240, a customer database 245, transactions storage 250, and programs 255 (including computer software for operating the web site 225) that allow the server to operate in accordance with the methods of the present invention.

Vendor database 230 preferably includes for each vendor, a vendor ID, vendor name, vendor address, and vendor contact information. A vendor is generally the manufacturer of a given medical product, but it may be another entity that is associated with the product.

Medical products database 235 preferably includes for each product, a product ID, product name, a vendor ID, product type to which the product has been assigned (if any), product sub-type to which the product has been assigned (if any), information regarding procedures in which the product may be used (e.g., a list of procedure IDs), an sku number, and vendor contact information such as who should be contacted when a user requests more information about the product, requests service, requests a vendor contact, requests a price quote, makes an order request, etc.

Procedures database 240 preferably includes for each medical procedure, a procedure ID, procedure name, and the product IDs for the products that are associated with (e.g., used in) the procedure. Products may include individual items, kits, packs, medical surgical products, and related capital equipment.

Products, product types and assemblies are associated with a vendor/supplier. This relationship enables a vendor/product preference card to be defined. The preference card can be used to select products including individual items, kits, packs, and medical surgical products from a preferred vendor/supplier or select a preferred product sub-type. The selection of a preferred supplier/vendor enables standardization and thus increases efficiency. While the increase in efficiency can be directly financial, standardization within a procedure, medical facility group or unit, enables the professional medical staff to be efficient and knowledgeable with their use of the preferred products. In service training, including video presentations and interactive computer assisted training can be used to raise the skill levels of the professional medical staff with respect to the preferred products. When a new product is selected as a preferred product, the professional medical staff can select the new preferred product and receive access to substantial information enabling them to become knowledgeable with respect to the new preferred product. In one embodiment, professional staff skills can be tracked and in-service presentations tracked, providing a degree of certification before they utilize the new product. By tracking staff skills associated with products and associating product/vendor preference with staff training/skills procedural efficiencies can be improved, reducing complications and improving patient recovery and prognosis. The preference card can be defined for specific personnel, or generalized to a group, unit or facility. The preference card can be dynamically updated by the results on in-service training and other indicators.

The use of preference cards can be coupled with the filters enabling purchase requests to be restricted to both qualified individuals as well as qualified products and vendors. This enables improved efficiency as well as the ability to maintain standardization and restrict product selection to those, which the facility and/or individual end users (physicians/nurses) are qualified (trained) on the proper use of. Preference cards can be associated with multiple levels, facility, specialty group and individual physician. This enables the potential reduction in malpractice issues. Standards of care can be directly coupled with the equipment and expendable parts that are necessary and approved for their implementation, thus automating and documenting the following of standards of care.

Preference cards and filters can be a function of training and continuing education. Thus, by coupling an interactive on line multimedia training program, clinical competency levels can be maintained at the medical facility on an on going continuous automatic basis. Users can be alerted to future and current requirements as well as restrictions can be applied to those not qualified for a new procedure/product or who have not been requalified as mandated by policy.

Customer database 245 preferably includes for each customer, a customer ID, a customer name, the organization (e.g., hospital, clinic, office) the customer is affiliated with, the customer's job title, the customer's specialty, the customer's address information, and the customer's password or other secured-access information.

The system also stores transaction information in a transactions database 250. This database may store vendor requests made by the customers, purchase order information, and other relevant transaction information.

As will be seen, the computer system network (server) 102, via a web site 225, provides users with unique searching and information retrieval capabilities, and also provides a multi-channel information request mechanism that allows users to quickly and easily construct and transmit various requests to the vendors of the medical products and to others. The users of computer system network (server) 102 are generally medical personnel such as doctors, nurses, and hospital administrators who are interested in obtaining information about the medical products stored at computer system network (server) 102, comparing attributes of the medical products, making various requests of the vendors of the products, and ultimately purchasing the medical products.

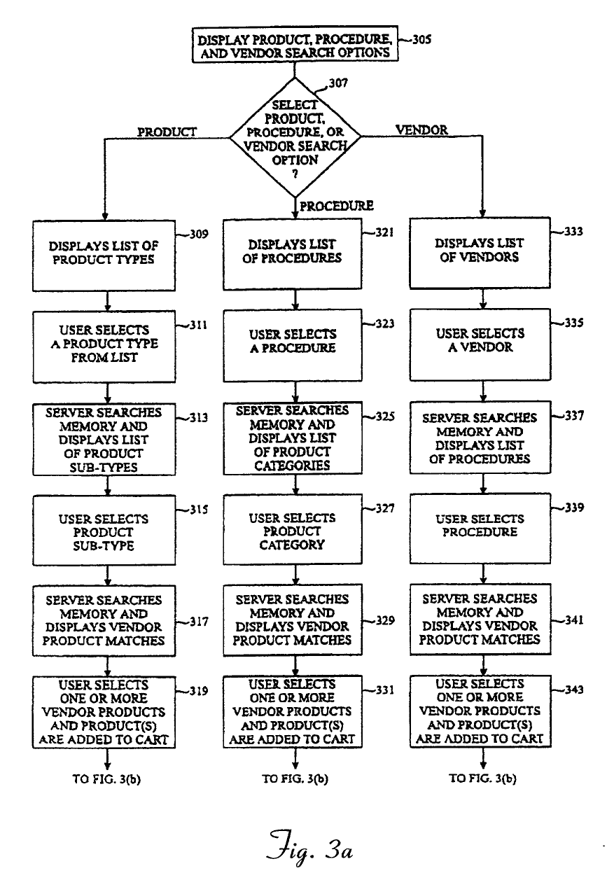

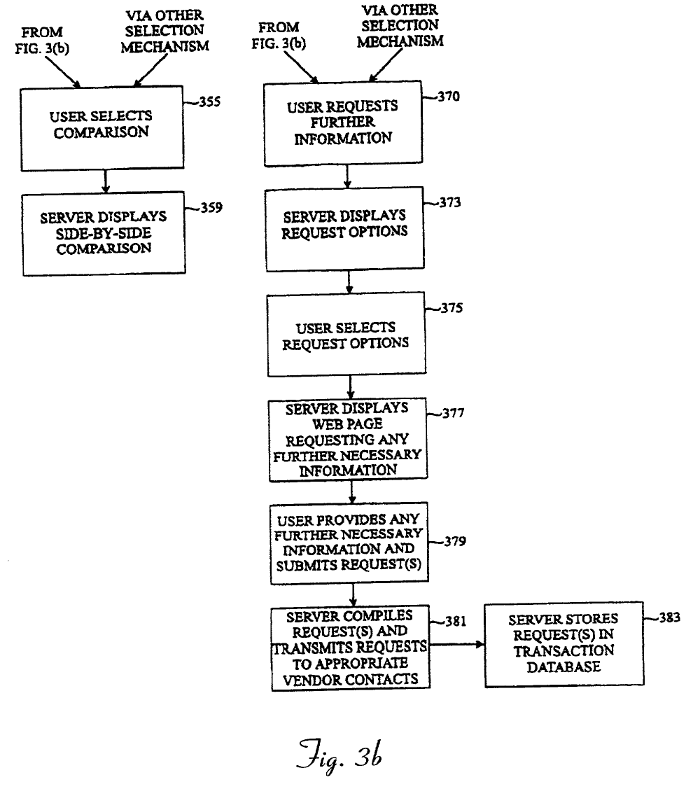

FIG. 3(a) is a flowchart demonstrating the preferred methods of providing information about the medical products. As illustrated by step 305, when a user initiates a search on the web site 225 the computer system network (server) 102 preferably displays on the user's computer a web page that allows the user to search the medical product information stored at computer system network (server) 102 via a product search mechanism, a medical procedure search mechanism, or a vendor product search mechanism.

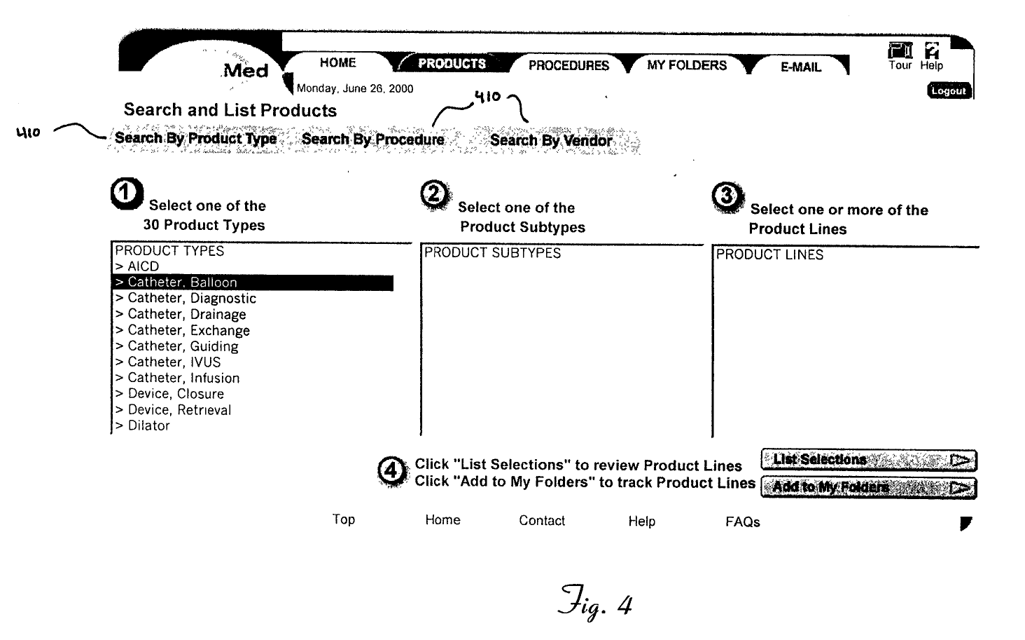

FIG. 4 is an illustrative web page that the computer system network (server) 102 provides in response to a user search request. As indicated by FIG. 4, the default search option is the product search option. However, the user may choose (step 307) between the three search options by clicking on tabs 410 (or via some other mechanism) provided on the web page.

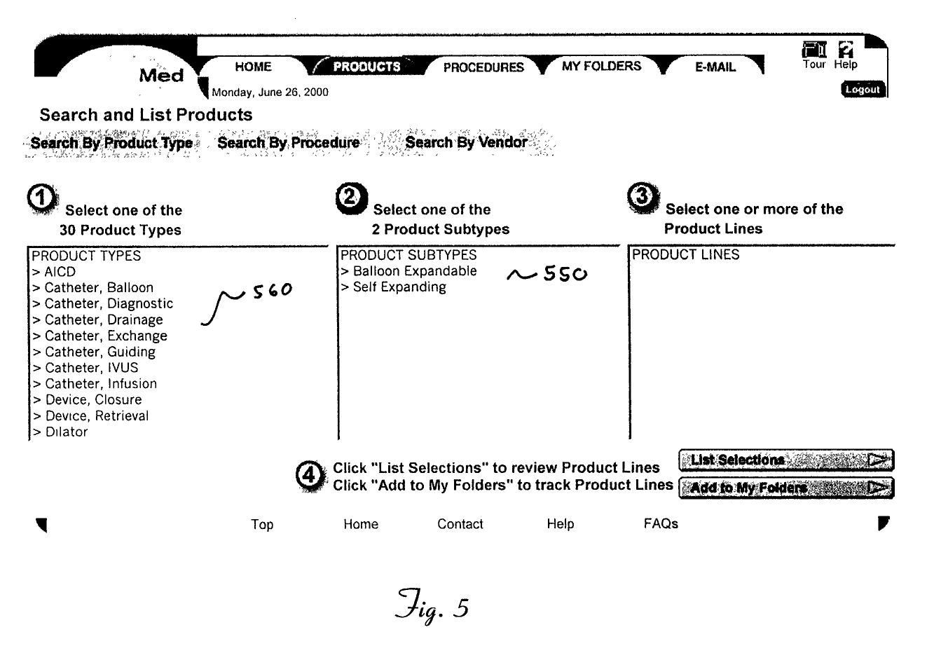

If the user chooses to utilize the product search mechanism, the computer system network (server) 102 preferably provides (step 309) a list of product types in a product-type box 420, along with empty product sub-type 430 and vendor product match 440 boxes. As illustrated by step 311, the user may then select a product type category, e.g., “stents” from the list shown in FIG. 4. In response to that selection, the server searches memory 210 and displays (step 313) on the user computer a list of product sub-types that match the selected product type. FIG. 5 is an illustrative web page showing a list of product sub-types 550 that match the selected product type “stents” 560. While, in this example, the server found only one product sub-type (“balloon expandable”) that matched the selected product type (“stents”), it is understood that the search could result in none or several matches being displayed on the user computer.

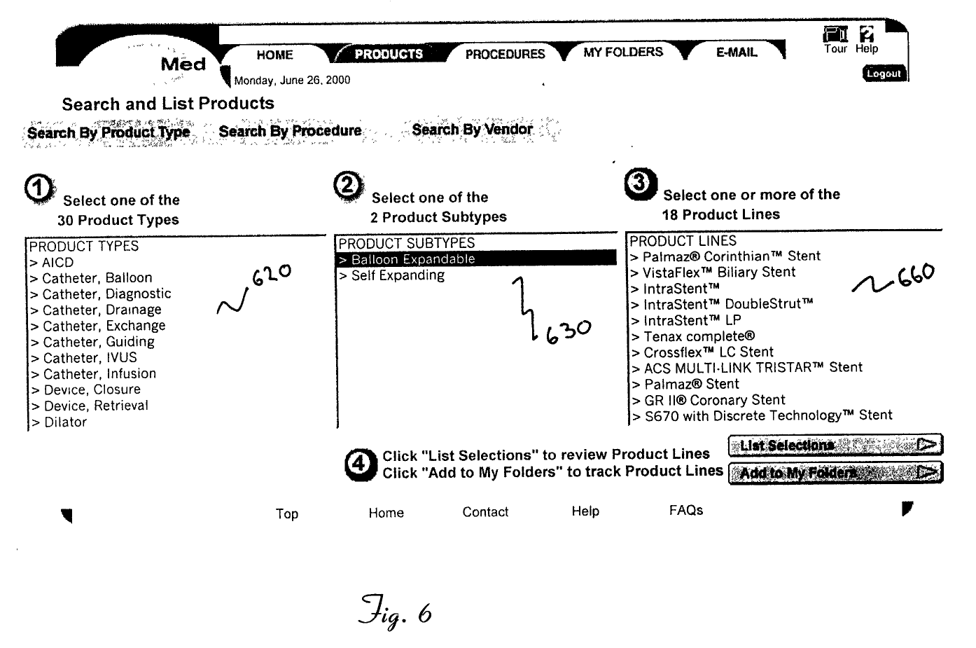

The user may then select (step 315) a product sub-type from the list displayed on the web page. In response to the user's product sub-type selection, the server searches memory 210 and displays (step 317) a list of vendor products matching the user's product type and product sub-type selections. FIG. 6 is an illustrative web page showing a list of vendor products 660 responsive to the user's product type 620 and product sub-type 630 selections.

As can be seen, the product search mechanism allows users quickly and easily to find different vendor products that compete in a given product area. And, advantageously this search mechanism is provided via an easy-to-follow and intuitive display format.

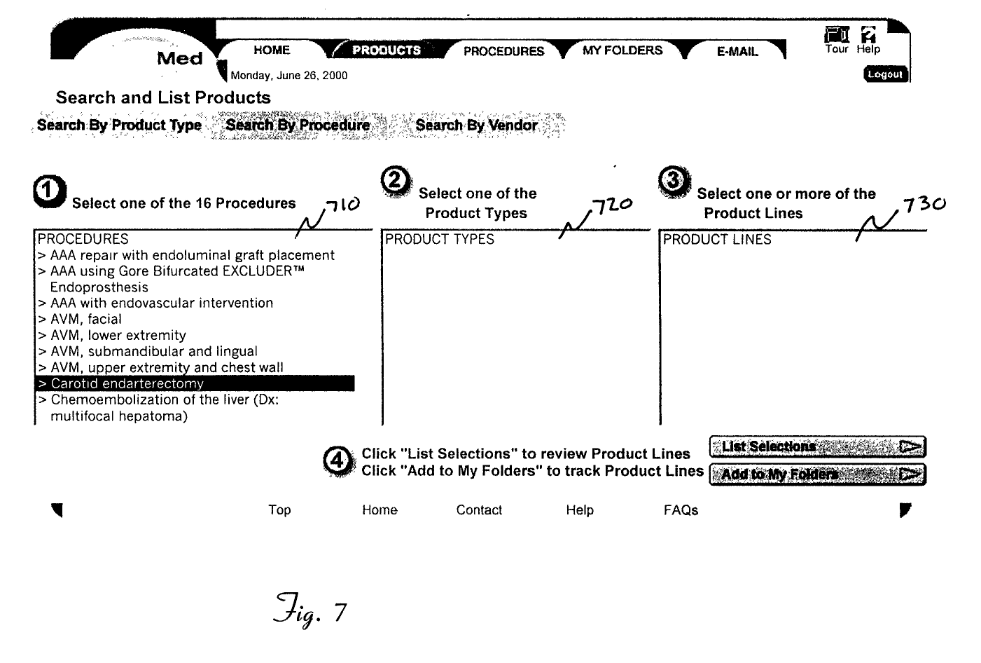

If the user selects the procedure search mechanism at step 307, e.g., by clicking on (selecting) the “By Procedure” tab 410 of FIG. 4, the server displays (step 321) on the user computer a list of procedures. An illustrative web page showing the procedure search mechanism is shown in FIG. 7, wherein a list of procedures is displayed in a procedure box 710, along with empty product type 720 and vendor product 730 boxes.

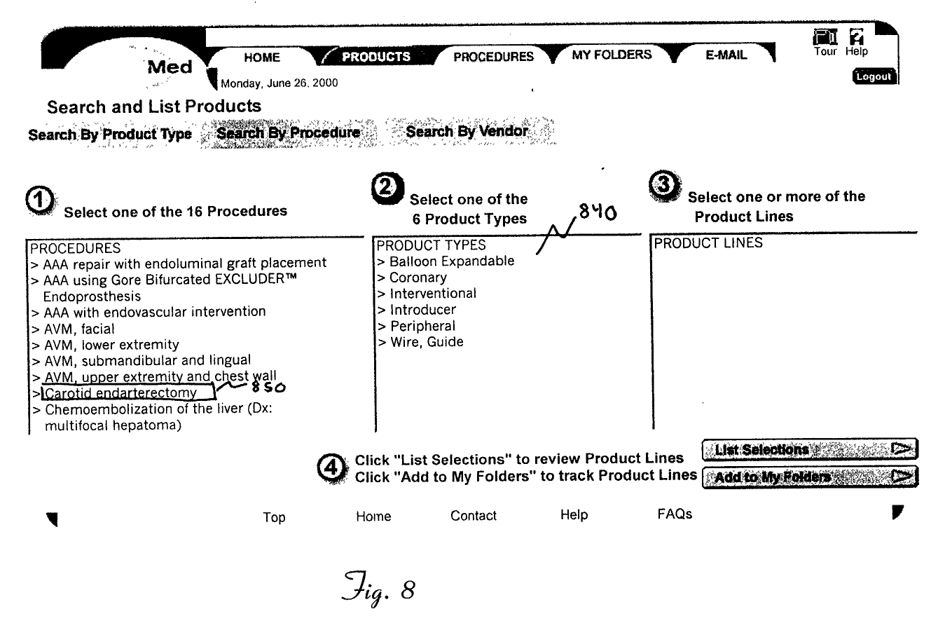

If the user selects (step 323) one of the listed procedures, the server searches memory 210 and displays (step 325) on the user computer a list of product categories. FIG. 8 is an illustrative web page listing product categories 840 that are associated with the user's selected procedure 850. This list of product categories may include product types, product sub-types, or both; but in the preferred embodiment, the server displays both product type and product sub-type categories.

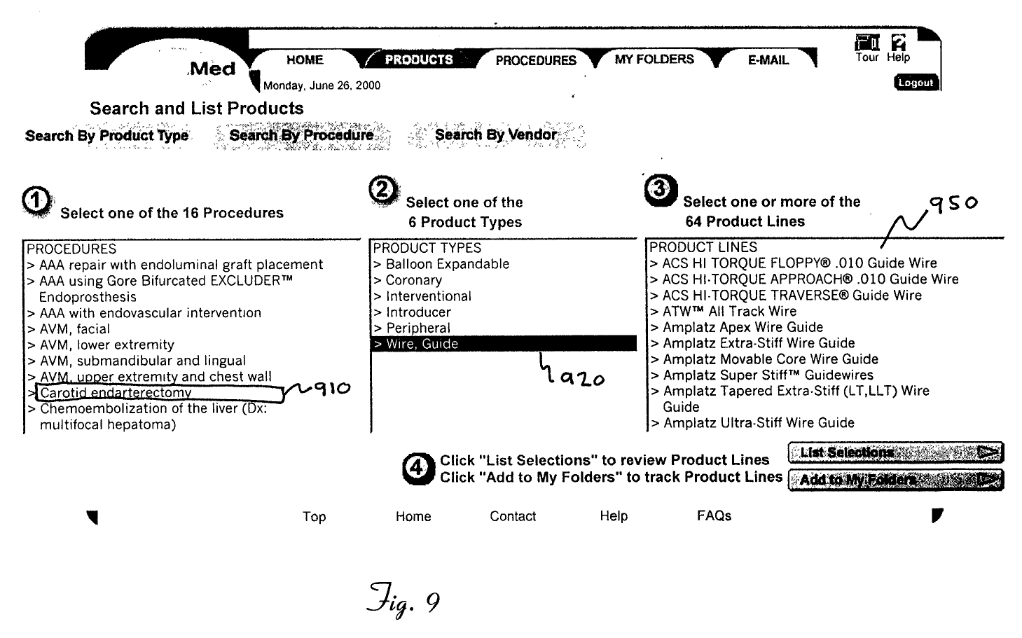

From this display, the user may then select (step 327) a product category. In response to the selection, the server displays (step 329) a listing of vendor products 950 (see FIG. 9) responsive to the user's procedure 910 and product category 920 selections.

While a preferred procedure search mechanism has been described, variations of the mechanism may also be utilized. For example, in response to the user selecting a procedure, the server may display a listing of product sub-types appropriate for that procedure, which may then be selected so as to display matching vendor products. Moreover, a fourth search step may be added to the preferred procedure mechanism such that the server displays product sub-types in response to the user selecting a product type. The server would then display matching vendor products in response to the user selecting a product sub-type.

This procedure search mechanism uniquely allows users quickly and easily to gather information about different vendor products that may be utilized in specific medical procedures. This procedure-specific search engine provides a powerful tool for doctors who are interested in reviewing different vendor products that may be utilized in the medical procedures relevant to their practices.

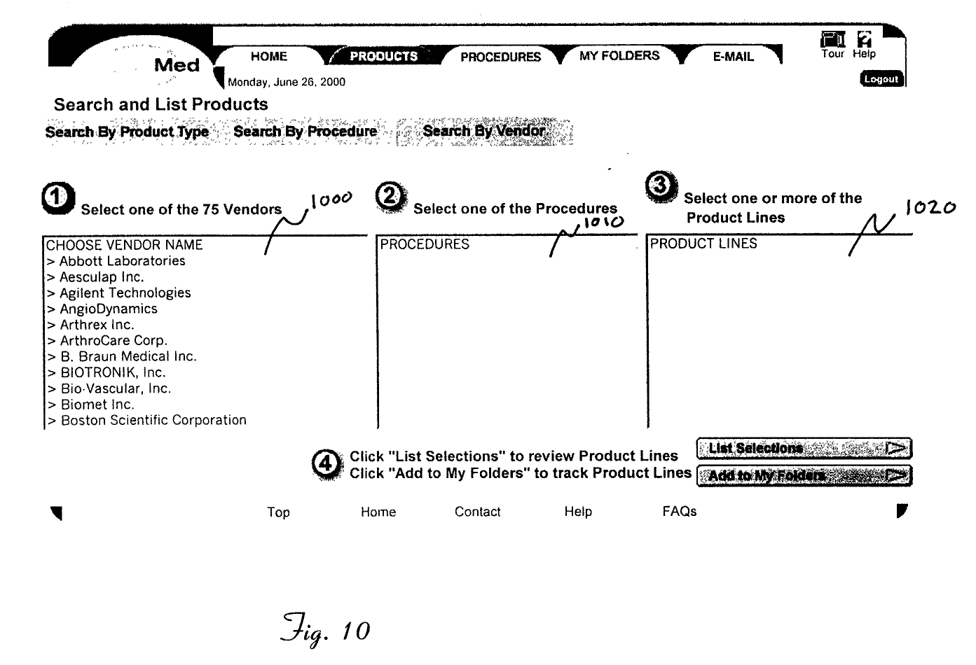

If the user selects the vendor search mechanism at step 307, e.g., by clicking on the “By Vendor” tab 410 of FIG. 4, the server displays (step 333) on the user computer a list of vendors. FIG. 10 is an illustrative web page showing the vendor search option, wherein a list of vendors is displayed in a vendor box 1000, along with empty procedure 1010 and vendor product 1020 boxes.

If the user selects (step 335) one of the listed vendors, the server searches memory 210 and displays (step 337) on the user computer a list of procedures for which the selected vendor is a supplier. In the preferred embodiment, the user may then select (step 339) a procedure, and in response the server searches memory 210 and displays (step 341) a listing of vendor products responsive to the user's selected vendor and procedure selections.

This vendor search mechanism allows users to quickly and easily identify a given vendor's products that may be utilized in a specific medical procedure. Importantly, this allows users to quickly “standardize” the medical products used in a given medical procedure through the use of medical products from a single vendor. This standardization can further be reflected in the qualification/certification of the medical professionals to reduce liability and potential errors.

In the preferred embodiment, in each of the product, procedure, and vendor search mechanisms, the lists displayed in response to user search requests may be filtered by the medical specialty of the particular user. For example, a dermatologist would receive lists of product categories, procedures, etc. that are relevant to his practice, while a heart surgeon might receive lists of product categories, procedures, etc. that are relevant to the surgeon's practice. This filtering could be done automatically based on the user ID that is provided by the user when logging onto the web site. Alternatively, the user may select from a list of specialties or similar categories so that his search requests are appropriately filtered.

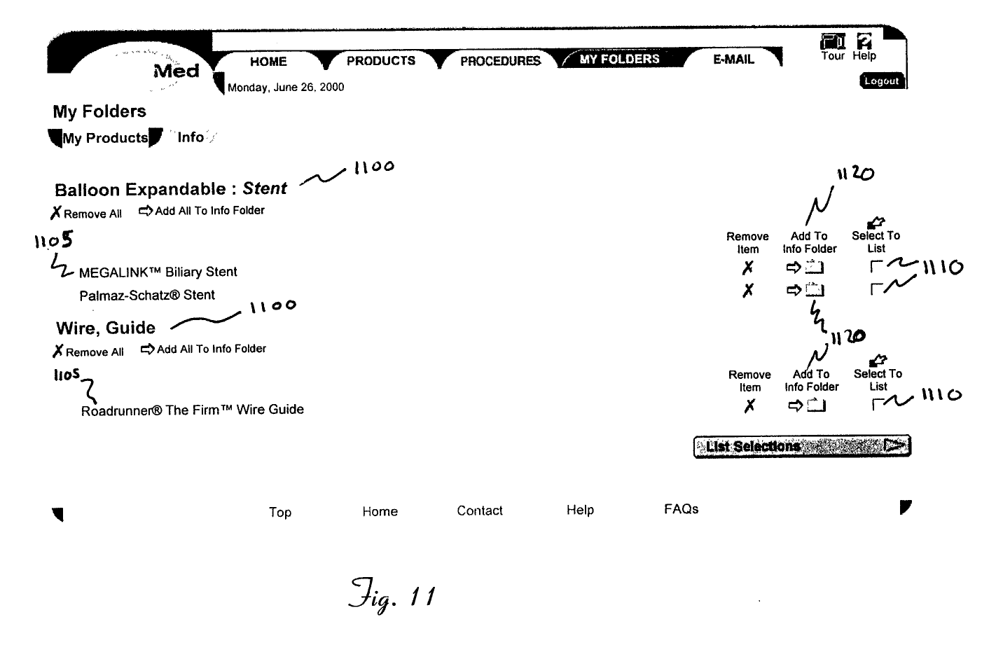

Once the server has displayed a list of the vendor products pursuant to any of these search methods (see, e.g., FIGS. 6 and 9), the user may select (steps 319, 331, 343 of FIG. 3(a)) one or more of the products in order to obtain information about them. In the preferred embodiment, the user's selected medical products are placed in a metaphorical folder that is stored at the user's computer. The user may then set up one or more vendor requests or select a medical product comparison feature for the products in the folder. An illustrative web page allowing the user to choose between these options is shown in FIG. 11.

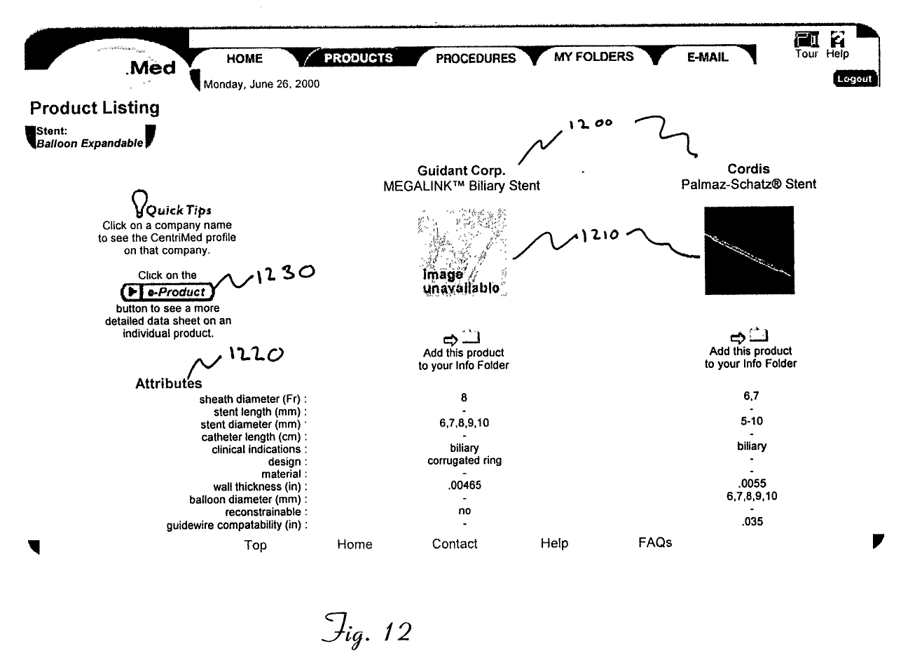

The web page of FIG. 11 shows the contents of the metaphorical folder, and preferably lists by product category 1100 and vendor 1105 the products that the user has selected. (As discussed above, this folder may be loaded with the vendor products that have been selected via the search mechanisms described above. However, other mechanisms may be utilized to load medical products into the folder; e.g., keyword searching or other browsing techniques may be used by the user to locate and select an item for the folder.) From this page, the user may choose to compare the two balloon expandable products that the user has previously selected by, e.g., clicking on their select boxes 1110, and then clicking on “list selections” 1115. Alternatively, the user may choose to set up a vendor request by, e.g., selecting a product, adding it to the information folder by clicking on “add to info folder” 1120. But other mechanisms of selecting a product for a vendor request may of course be utilized. By way of example, in an alternative embodiment, if a user selects a vendor product on one of the search page lists or via some other browsing mechanism, that product is automatically added to the info folder. Advantageously, the user may also elect to name the folder by typing a name in box 1150 so that it can be easily searched at a later time. As illustrated by step 355, if the user selects products to compare, the server responds by displaying 359 the selected products side-by-side. An illustrative web page showing a comparison between two selected products is shown in FIG. 12. Advantageously, the server displays the selected products side-by-side, and preferably provides for each product, a description 1200, an image 1210, and summary attribute information 1220. The user may also select a button 1230 to request a web page with further information about a product.

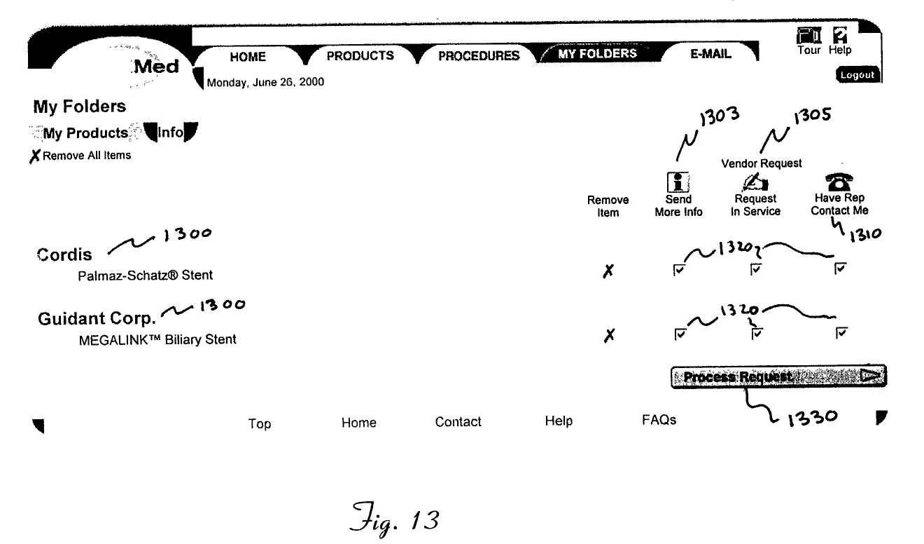

As illustrated by step 370, if the user decides to request further information about the selected medical products (e.g., by clicking on tab 1130 of FIG. 11), the server displays 373 on the user computer a list of options from which the user may choose to obtain further information on the selected medical products. As shown in FIG. 13, the server preferably displays the selected products by vendor 1300, and for each selected product, allows the user to request more information 1303, request service 1305, request contact from a vendor representative 1310, and/or make an internal request. In the preferred embodiment, a user makes these requests by clicking on boxes 1320, and subsequently clicking on “process request” 1330. But other methods of selection, which are well known may be utilized. The user may also elect to name this version of the folder by typing a name.

After the user has made the information request selections and submitted them (step 375), the server may display (step 377) a web page confirming the requests and requesting any further information that may be necessary to complete the request(s). The user may provide updated contact information (the server uses the customer's information stored in memory to automatically populate the displayed existing contact information), provide time response requirements, etc. The user may also draft a memo and provide e-mail addresses or other relevant contact information for individual(s) receiving the request message. After verification of the entries the user selects the “send now” button.

At step 379, the user may then transmit the request(s) to the server, which then compiles (step 381) the requests. The server accomplishes this by searching memory 210 for the respective vendor contacts that are associated with the user's selected medical products. Next, the server transmits the requests to the identified contacts via e-mail, FTP, or via some other communication. As illustrated by step 383, the server also stores the requests in transactions database 250.

Advantageously, a user can later review his submitted information requests by simply logging on to the web site, and reviewing his stored folders. This review could be done by simply scrolling through the folders assigned to him, or via a keyword search where the user could, e.g., search by product name, vendor, or by folder name. If the user has placed purchase orders for selected products, information regarding the status (e.g., in transit, out-of stock) of such orders is also provided.

The system provides the definitive physician specialty portal. Within the system specialty portal, the physician home page provides content filtered for their individual specialty. This page serves as the gateway into the detailed product and procedure searches supported by the system. In addition, physicians may access professional, education tools filtered for their specialty, news items supplied by manufacturers and news that affects their specialty. Users (physicians) may also customize their page with their preferred news sources, stocks, weather and links to other sites.

State-of-the-art calendaring functionality allows physicians online access to their schedules, as well as industry events, trade shows, educational programs and any information that affects their specialty, their hospitals and their local community. By tying into hospital scheduling systems, the system provides office managers the ability to view a consolidated schedule of different hospitals and scheduling systems, and incorporate the physician's office and personal scheduling. The system enables physician peers to view each other's schedules and for manufacturer sales representatives to view open scheduled times to optimize scheduled events.

Discussion groups, presented by specialty, connect physicians to peers currently performing new procedures, completing clinical trials of new products and discussing new techniques for providing the best care with optimized outcomes.

A search provides free access to the comprehensive clinical and peer-reviewed article database of Medline.

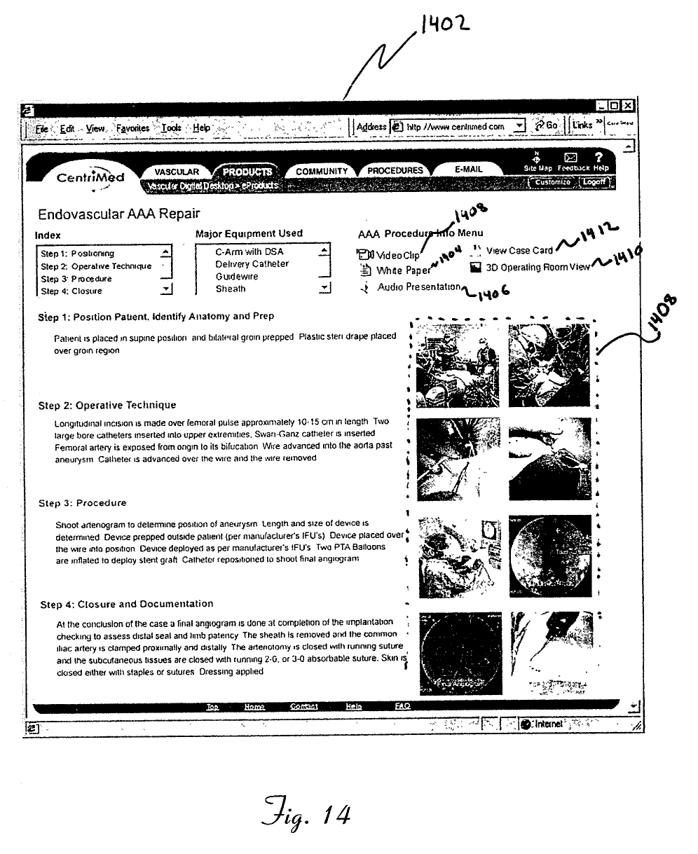

Referring to FIG. 14 there is shown an exemplary screen display 1402 of the physician specialty portal procedure detail. The system captures state-of-the-art procedural information performed by its thought-leading physicians in each specialty. In addition, multiple information types are available for each procedure; preference card 1412, white paper 1404, audio 1406, video 1408 and 3-D operating room view.

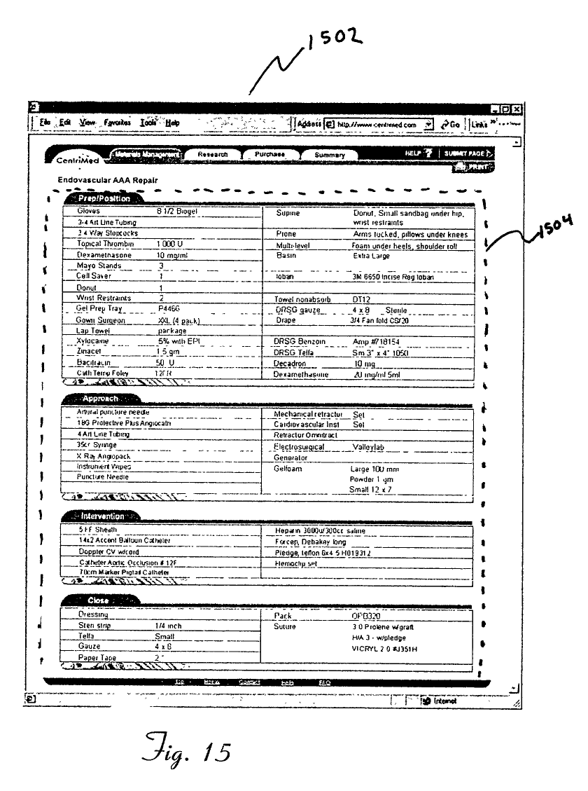

Referring to FIG. 15 there is shown an exemplary screen display 1502 of the physician specialty preference card. The system provides a dynamic interface for hospitals to create customized preference cards 1504. These cards can be displayed in various templates, organized by procedural steps, by product class or by item. Operating room technicians complete the hospital standard preferences and physicians add their preferred equipment, devices, or pharmaceutical supplies. This functionality allows materials managers to drive standardization across numerous preference cards 1504, and provides utilization reports by physician, product type, procedure and department.

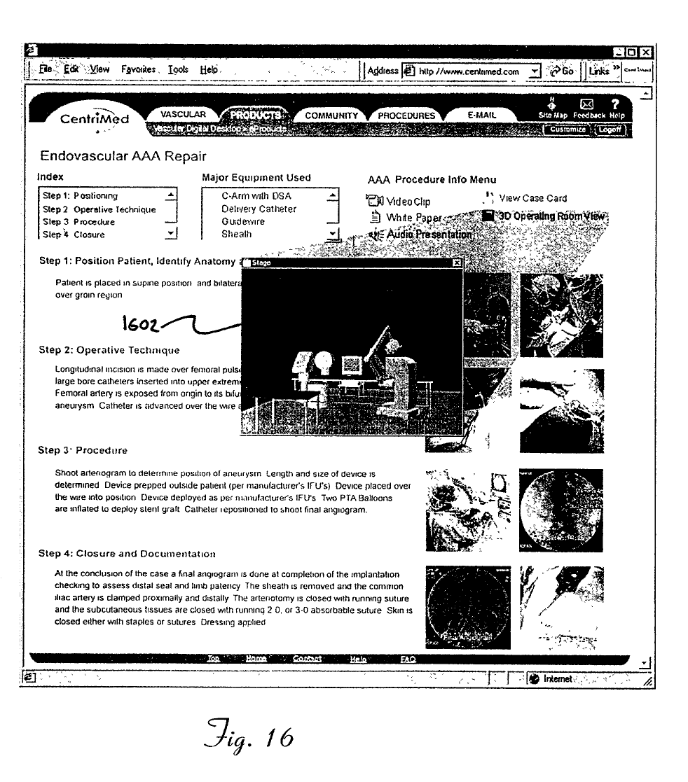

Referring to FIG. 16 there is shown an exemplary screen display of the physician specialty portal procedure with 3-D view 1602. Virtual access into the OR is permitted utilizing a 3-D reconstruction of the room.

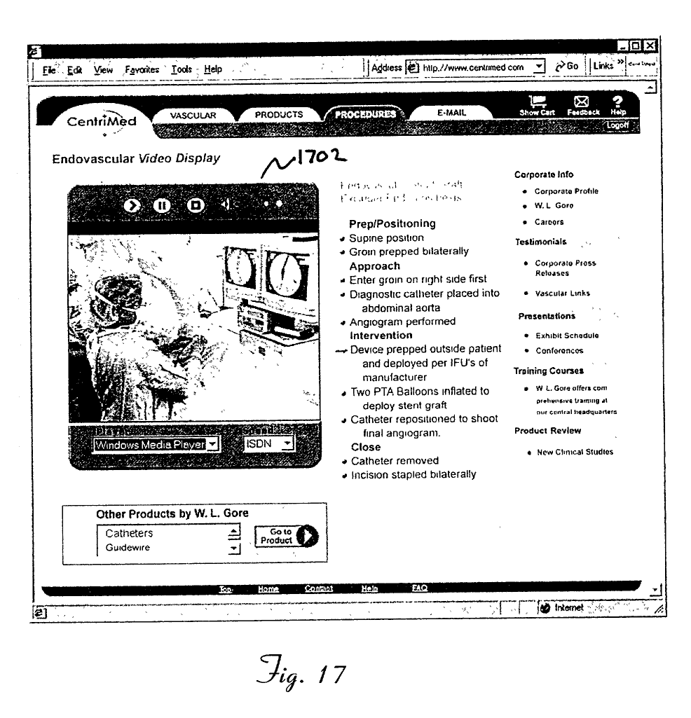

Referring to FIG. 17 there is shown an exemplary screen display of the physician specialty portal video display 1702. Specialty physicians have access to leading edge procedures, being performed by recognized industry leaders.

The system connects all members of the healthcare device supply chain. For the first time, physicians are connected electronically and seamlessly into the purchasing process. Workflow roles are defined, such as “recommender,” “team leader,” “department manager.” Individual users become members of a role type. Users may serve different roles in different organizations, for example, a physician is a recommender in a large hospital, an approver in a clinic, and a buyer in the office. The routing of a work item is determined by the business and routing rules set by standardized, customizable workflow templates. Workflow is determined on an SKU basis, allowing one purchase request to spawn multiple actions. This prevents order delay based on non-approval of individual items in the purchase request.

The true power of a connected ordering environment becomes apparent as new line-item orders may be entered from the central product database, and not added by hand, reducing errors. In addition, by creating simple reorder templates, standing order templates, and Packs ordering templates, all driven from a central SKU database, order transaction is significantly streamlined. Purchase order pricing, preference card pricing and budgeting functions all access the latest earned discount levels ensuring that pricing is always accurate to hospital IDN or vendor-maintained price contracts, which eliminates pricing errors.

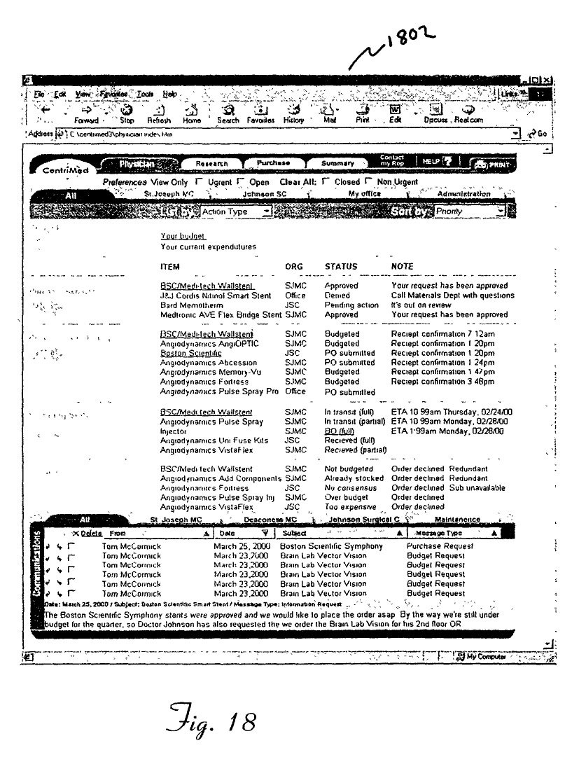

Referring now to FIG. 18 there is shown an exemplary screen display 1802 of the e-commerce dashboard. E-commerce provides a real-time dashboard report of all action items pending user intervention; purchase requests needing approval, purchases pending, shipments pending and received items. This report segments work by action item, by urgency, by time submitted/time due, by organization and sub-organization (Operating Room, Cath lab, Surgery Center).

Due to the asynchronous nature of the workflow system, action items queue for user-intervention at the appropriate location and wait for action. Multiple logical paths through the organization may be defined, ensuring that one role member does not delay the entire process.

One purchase request with multiple vendors' products automatically generates multiple individual vendor purchase orders. Each purchase order accesses the central database of product-SKU-price information to determine up-to-the minute pricing, as determined by contracted purchasing and any volume/compliance discounts negotiated at the hospital, IDN or vendor level.

Details on the status of each order are available, allowing materials managers to gather real-time information on outstanding orders. Based on SKU-level workflow, users are able to access shipping status for each line item in a shipment, and are able to receive partial shipments.

The system workflow structure includes content based routing, split routing, purchasing dashboard, purchase request to purchase order aggregation and cross organizational workflow. Content based routing is the ability to dynamically create a routing workflow structure based on the individual items within a work object or by the total workflow object. The workflow routing structures are based on business rules. Split routing is the ability to take a work object, break it into its distinctive parts, and then route it using a workflow engine based on the business rules that apply to each distinct part. The system can also reassemble the work object after all of the components have completed their workflow route. Purchase request to purchase order aggregation is the ability to take multiple purchase requests, divide them into their discrete work items, and then reassemble them into different multiple purchase orders. Cross-organizational workflow is workflow connected across an organization such as: physician office—hospital; physician office—surgery center; hospital—distributor; hospital—supplier; supplier—distributor; or, supplier—third part logistics.

In one exemplary embodiment of the present invention, an SKU/Electronic Catalog Subsystem through a database such as Oracle Database that will, in time, encompass the SKUs for all medical related products used globally. This database catalog captures product information primarily by SKU number, vendor code, model number, product type, product subtype and product attributes (for associative purposes). Through this SKU Catalog Subsystem, all users are able to quickly access detailed product information. The application and system software can be implemented in a variety of programming languages and tools that are known to those skilled in the art of on line software development. Particular selections of programming languages are development tools are a matter of choice dependent on existing hardware, software and architectural structures. The choices are readily apparent to those skilled in the art of on line software development.

Action control and access personalization enable a user to only see work items for which they have authority. This access control is implemented through the use of predefined filters. A particular user (who's access is authenticated) is associated with a set of default filters. When a user's authentication fails, the authentic user is notified such as by e-mail. This notification can be set based upon what may be considered an excessive number of failures, which can be correlated to the level of access the authenticated user has. Examples of filters points include: item status; item type; due date; creation date; originator; etc. The use of predefined filters enables a highly functional and customized access (personalized dashboard), including a custom user portal page, while maintaining uniformity and continuity for support and maintenance of the underlying system as well as providing common user subsets of access procedures and functionality.

While the present invention has been described with reference to the preferred embodiments, those skilled in the art will recognize that numerous variations and modifications may be made without departing from the scope of the present invention. This is especially true with regard to the display of information (action buttons, etc.) that allow the users to select from the various search options, to select products for the comparison and vendor request mechanisms, and to transmit information to the server. Such display mechanisms may be varied greatly without departing from the scope of the present invention. Moreover, while a preferred embodiment regarding the system architecture of the present invention has been disclosed in connection with FIGS. 1 and 2, in view of the foregoing description, other system architectures that can carry out one or more of the methods of the present invention may also be available, and all such other system architectures are contemplated to be within the scope of the present invention. For example, from the description of the database files in computer system network (server) 102, those skilled in the art will recognize that other database structures could be used that would still provide for the unique methods of the present invention, and all such database structures are contemplated to be within the scope of the present invention. It should also be noted that the operation of and the components that comprise the server could be distributed over a number of computer devices and systems.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claim, is reserved.

What is claimed:

1. A method for integrated management of medical information comprising the steps of:
maintaining a digital database of medical information including product, product source and procedure;
indexing the digital database of medical information by product, product source and procedure;
receiving a query for medical information;
searching the digital database of medical information by an index in response to the query for medical information;
cross referencing the information found by searching to another index;
filtering the response as a function of preference data;
transmitting information found by searching and cross referencing;
wherein access is provided to the medical information and the corresponding cross references.

2. The method as recited in claim 1 wherein access to the medical information and the corresponding cross references is a function of the preference data.

3. The method as recited in claim 2 further comprising formatting the information found by searching and cross referencing so as to be indicative of a selection of the preference data.

4. The method as recited in claim 1 wherein a selection of the preference data corresponds to qualifications of a particular user.

5. The method as recited in claim 1 wherein a selection of the preference data corresponds to a particular medical unit.

6. The method as recited in claim 1 wherein the index used for searching the database corresponds to a medical procedure.

7. The method as recited in claim 1 wherein a user may select products from a predetermined vendor for comparison.

8. The method as recited in claim 1 wherein a user may select products and request additional information from a corresponding supplier without requiring further user action.

9. The method as recited in claim I further comprising the step of initiating a purchase request for selected products from a particular vendor.

10. A system for integrated management of medical information in response to a request from a user computer comprising:
a database of medical information including product, product source and procedure;
an index corresponding to the database of medical information by product, product source and procedure;
communication device for receiving from a user computer a query for medical information;
search engine for searching the database of medical information by an index in response to the query for medical information;
means for cross referencing the information found by searching to another index;
means for filtering the information found;
communication device for transmitting information found by the search engine and generated by the means for cross referencing to the user computer;
wherein the user computer is enabled to access the medical information and the corresponding cross references.

11. The system as recited in claim 10 wherein the database further comprises preference data.

12. The system as recited in claim 11 further comprising means for formatting the information found by searching and cross referencing so as to be indicative of a selection of the preference data.

13. The system as recited in claim 11 wherein the selection of the preference data corresponds to a particular user.

14. The system as recited in claim 11 wherein the selection of the preference data corresponds to a particular unit.

15. The system as recited in claim 11 wherein the preference data corresponds to a product supplier.

16. The system as recited in claim 10 wherein the index used for searching the database corresponds to a medical procedure.

17. The system as recited in claim 10 wherein the user may select products from a predetermined vendor for comparison.

18. The system as recited in claim 10 wherein the user may select products and request additional information from a corresponding supplier without requiring further user action.

19. The system as recited in claim 10 wherein the selection of the preference data corresponds a particular level of skill/training with respect to a product.

20. The system as recited in claim 19 wherein the means for filtering is a function of the particular level of skill/training with respect to the product.
